(19) United States
(12) Patent Application Publication
(10) Pub. No.: US 2025/0058532 A1
(43) Pub. Date: Feb. 20, 2025

(54) PRE-IMPREGNATED FIBER DEPOSITION HEAD WITH LASER HEATING ADJUSTMENT DEVICE

(71) Applicant: DAHER AEROSPACE, ORLY (FR)

(72) Inventors: Julien Moothoo, Bouguenais (FR); Antoine Lespinasse, Nantes (FR)

(21) Appl. No.: 18/376,095

(22) Filed: Oct. 3, 2023

(30) Foreign Application Priority Data
Oct. 4, 2022 (FR) 2210166

(51) Int. Cl. B29C 70/38; B29C 37/00; B29C 70/54

(52) U.S. Cl. CPC B29C 70/384; B29C 37/00; B29C 70/54; B29C 2037/903

(57) ABSTRACT

The invention pertains to a deposition head (200) for automated layup of pre-impregnated fibers (110) onto a deposition surface (101) comprising a laser heating device in the vicinity of the deposition site via an optical device (250) and comprising a device adapted to adjust the positioning of said optical device relative to the deposition site in order to obtain heating conditions adapted according to the intended lay up operation.

### TECHNICAL FIELD

The invention relates to a head for the automated layup of pre-impregnated continuous fibers, comprising a laser heating means and a device for adjusting the laser spot produced by this heating means.

The invention is more particularly, but not exclusively, suitable for the layup of fibers impregnated with a thermoplastic polymer by tape layup or fiber placement.

### BACKGROUND ART

Automated fiber deposition is carried out by a machine comprising means for unwinding said fibers pre-impregnated with a thermosetting or thermoplastic polymer, in the form of strips or rovings of continuous fibers, which are applied to a substrate by a deposition head comprising a roller, the fibers being deposited between the roller and the substrate, the roller exerting pressure on the fibers so as to apply them on the substrate and obtain their adhesion thereto.

The deposition head is supported by a programmed displacement device, such as a robot or a machine tool, and moves relative to the substrate according to defined trajectories and speed so as to layup successive layers of fibers thereon and thus making a composite structure of laminate plies.

The substrate generally consists of impregnated fibers which have been laid-up during a previous pass and which constitute a ply in the composite structure, the same ply having itself been laid-up on a previous ply.

More particularly in the case of fibers impregnated with a thermoplastic polymer, this adhesion occurs only if the polymer impregnating the fibers is heated to a temperature high enough, of the order of its melting point, and the pressure is applied for a tome long enough to trigger the phenomena of adhesion or autohesion.

Depending on the nature of the thermoplastic polymer impregnating the fibers, the heating temperature at the deposition site is commonly comprised between 200° C. and 400° C. but may be higher.

This high heating temperature should affect both the fibers just before they are deposited on the substrate, in the area where the fibers meet the substrate, as well as the substrate, both in the depositing area as well as in front of it in the moving direction of the deposition head.

In order to obtain adequate pressure and application time without overly slowing down the layup speed, which easily reaches 30 m/min during fiber placement operations, the roller applying this pressure is deformable, so that the pressure is applied according to a substantially rectangular surface extending over a width corresponding to that of the roller and, relative to the deposition direction, behind the contact between the roller and the deposition area, depending the deformability of the roller and on the exerted pressure.

The document “High power diode laser-assisted fiber placement of composite structure”, John M. Haake, Westec 2005 Conference Apr. 4-7, 2005 in LA California, describes different heating techniques used during fiber placement operations of fibers impregnated with a thermoplastic polymer and the advantage of using laser heating compared to other prior art techniques.

Document WO 2016/055700 describes a method for placing fibers impregnated with a thermoplastic polymer, implementing a deposition head equipped with a heating system to heat, during the layup, the fiber to be laid-up and the substrate, just upstream of the roller in relation to the direction of the head, and thus welding the fiber to the substrate. The heating system is of the laser type and includes an optical device attached to the head. The laser beam emitted by a remote source relative to the deposition head is conveyed via an optical fiber to the optical device configured to form a laser beam towards the contact line between the roller and the substrate.

In such a device of the prior art, the optical device is mounted articulated with respect to the depositing head so as to be able to adjust the orientation of the laser beam in space and to position the heating zone with respect to a nip line, that is to say where the roller meets the depositing surface in the depositing direction.

The power lasers used for the heating of the deposition site have a power commonly comprised between 1 KW and 12 KW. These deposition heads are additionally equipped with a pilot laser, of reduced power and following the same optical path as the power laser, which pilot laser is used for the adjustment of the optical device.

For example, the power laser used for heating is in the near infrared spectrum (wavelength 1000+/−20 nm) and the pilot laser is in the visible spectrum (wavelength 650 nm) with a power of the order of one watt.

In a plane perpendicular to the power laser or to the pilot laser, the optical device projects a laser spot, generally rectangular in shape, the power distribution in this spot being relatively homogeneous, when this perpendicular plane is located between the lens of the optical device and the focal plane at a distance called the working distance of the optical device.

To achieve the desired heating effect, it is necessary to position this laser spot appropriately relative to the deposition point, i.e. the nip line between the roller and the deposition surface.

The positioning tolerance of the laser spot is less than one millimeter.

However, depending on the nature of the fibers deposited, the width and thickness of the rovings or strips, the pressure applied by the roller, the more or less deformable nature of said roller adapted to the targeted operation and the angle of inclination of the deposition head relative to the depositing surface, the position of the nip varies in space and therefore requires that an adjustment of the optical device be carried out prior to a layup operation.

In addition, the position of the optical device is likely to drift over time, as well as the roller to wear out, and as a result, regular adjustments are required even on a machine always performing the same operations with the same materials.

Poor adjustment of the optical device leads to poorly adapted heating, likely to cause defects in the composite parts thus made.

Certain layup methods, as described for example in documents U.S. Pat. No. 10,016,931 and U.S. 2018 0319102A1, require precise control of the temperature at the deposition site and consequently precise positioning of the laser spot.

However, when the roller is applied with appropriate pressure on a surface, accessibility to the concerned area is uneasy, in addition, the observable scene does not include any plane perpendicular to the laser, the roller is cylindrical and the deposition surface is neither parallel nor perpendicular to such a plane so that the visual estimation of the position of the laser spot is very subjective, depending heavily on the operator and does not in any case achieve the desired positioning accuracy.

### SUMMARY OF THE INVENTION

The invention aims at solving the shortcomings of the prior art and for this purpose pertains to a deposition head for automated fiber layup of pre-impregnated fibers on a deposition surface comprising:
an application roller capable of rotating around a rotation axis carried by the deposition head, the application roller being removable and positioned relative to the head by reference surfaces,
pressure means configure for applying an application pressure of the application roller to the deposition surface,
a heating laser configured for heating the pre-impregnated fibers and the deposition surface during automated layup,
an optical device configured for focusing the heating laser to project a laser spot with a power distribution in the laser spot at a working distance, the optical device being connected to the deposition head by an adjustable polyarticulated linkage, configured to adjust a relative position of the optical device with respect to the deposition head,
a pilot laser of reduced power as compared with the heating laser, configured to use the optical device,
   the deposition head comprising:
an adjustment device adapted to be installed on the deposition head in place of the application roller and positioned in relation to the deposition head by the reference surfaces,
a translucent screen configured to receive a projection of the laser spot of the pilot laser by the optical device on a face exposed to the optical device,
the translucent screen being connected to the adjustment device by a pivot link lockable around a pivot axis,
a camera oriented towards a face opposite the exposed face of the translucent screen and able to acquire an image of the translucent screen, and
a control monitor configured for displaying the image acquired by the camera.

Thus, the deposition head of the invention makes it possible, via the pilot laser, to view and position precisely the laser spot projected by the optical device, in the reference frame of the machine and on a flat surface consisting of the translucent screen.

The invention may be carried out according to the embodiments and variants exposed hereafter, which are to be considered individually or according to any technically operative combination.

Advantageously, the deposition head comprises means for adjusting the position of the axis of the pivot link relative to the reference surfaces.

This embodiment allows, with the same adjustment device, to make adjustments adapted to different diameters of the application roller.

Advantageously, the deposition head comprises an inclinometer for adjusting an orientation of the translucent screen about the pivot link.

Thus, the initial adjustment of the adjustment device is simplified and more accurate.

Advantageously, the translucent screen comprises a grid on the exposed face.

This embodiment facilitates the determination of the scale factor between the pixels acquired by the camera and the dimensions of the observed scene.

The invention also pertains to a system comprising the deposition head according to the invention and computer means comprising calculation means configured to analyze the image acquired by the camera.

This system makes adjustments easier and partially automates them.

The invention also pertains to a method for the adjustment of the optical device of the deposition head system, comprising steps of:
I) calculating a position relative to the reference surfaces of a nip line of the application roller on the deposition surface when the latter is applied to the deposition surface with the application pressure,
II) obtaining target conditions for heating, by the heating laser, the deposition surface and the pre-impregnated fibers during the layup operation,
III) determining from a result of step II) an orientation angle α of the heating laser and a theoretical relative position of the center of the laser spot with respect to the nip line at the working distance,
IV) installing the adjustment device in place of the application roller,
V) positioning and orienting the translucent screen by its pivot link according to the orientation angle α determined in step III,
VI) projecting the laser spot onto the translucent screen with the pilot laser,
VII) acquiring the image of the laser spot with the camera and displaying it on the control monitor,
VIII) displaying on the control monitor the position of the theoretical position of the center of the laser spot obtained in step III,
IX) acting on the adjustable polyarticulated linkage to make the center of the image of the laser spot coincide with the theoretical position of the center of the laser spot displayed on the control monitor.

According to an embodiment, the method further comprises the steps of:
analyzing with the computer means a distribution of the light intensity of the laser spot acquired in step VII,
comparing the light distribution of the laser spot acquired in step VII with the power distribution of the laser spot projectable by the optical device,
deducing and displaying deviations from the comparison,
acting on the adjustable polyarticulated linkage to minimize the deviations.

Thus, the implementation of this embodiment allows a finer adjustment of the optical device so as to obtain an optimal distribution of the heating power.

Advantageously, the computer means comprise a kinematic model of the adjustable polyarticulated linkage, the method comprising steps of:
calculating an initial configuration of the adjustable polyarticulated linkage based on the position of the image acquired in step VII and the kinematic model of the adjustable polyarticulated linkage,
determining a target configuration of the adjustable polyarticulatd linkage to make the center of the laser spot image coincide with the theoretical position of the center of the laser spot displayed on the control monitor according to the kinematic model of the adjustable polyarticulated linkage,
displaying the target configuration on the control monitor,
during step IX acting on the adjustable polyarticulated linkage to reproduce the target configuration.

Thus, the adjustment of the polyarticulated linkage is made easier.

### BRIEF DESCRIPTION OF THE DRAWINGS

The invention is implemented according to the preferred embodiments, in no way limiting, exposed hereafter with reference to FIGS. 1 to 9 in which:

FIG. 1 shows in a partial view the deposition site in a plane perpendicular to the deposition surface and to the application roller rotation axis;

FIG. 2 schematically depicts a deposition head according to a side view in a plane parallel to the one of FIG. 1;

FIG. 3 shows an example of a laser spot projected by the optical device used for carrying out laser heating;

FIG. 4 shows an exemplary embodiment of the adjustment device in a rear view (on the deposition head side) as installed on the deposition head, the translucent screen holder being oriented parallel to the deposition surface;

FIG. 5 shows the device of FIG. 4 as installed on the deposition head, seen according to a top view, the translucent screen holder being oriented parallel to the deposition surface;

FIG. 6 is a simplified example in top view and partial cross section of an application roller installed on the deposition head;

FIG. 7 shows an example of a translucent screen installed on the adjustment device;

FIG. 8 schematically shows an exemplary embodiment of the system of the invention;

FIG. 9 is a flowchart of an exemplary embodiment of the method of the invention.

### DESCRIPTION OF EMBODIMENTS

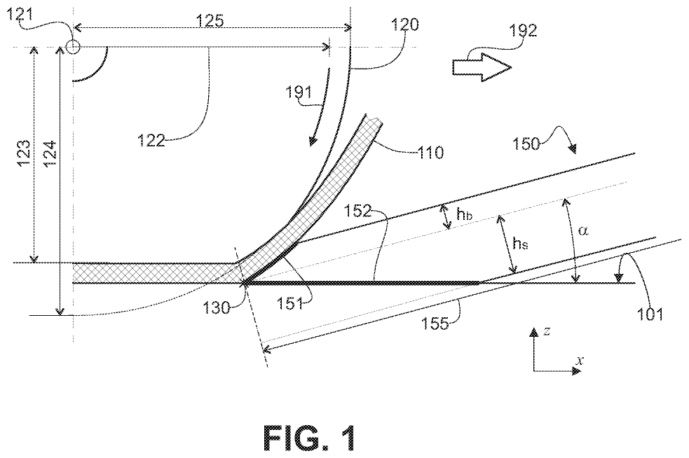

FIG. 1 schematically represents the automated layup of a strip of pre-impregnated fibers (110) on a deposition surface (101).

The strip of pre-impregnated fibers (110) is applied to the deposition surface (101) by an application roller (120), which roller moves parallel and relative to the deposition surface (101) according to a programmed deposition speed (192).

This relative displacement of the application roller at the deposition speed causes it to rotate around a rotation axis (121) perpendicular to the plane of the figure.

The application roller is characterized by its nominal radius (122) and by the material making it, which material is more or less flexible and defines the deflection of the application roller under the effect of the pressing force applied thereto.

Under the effect of the pressing force, the section of the application roller takes a flattened elliptical shape by the contact with the deposition surface.

Thus, the shape of the application roller, deformed by the pressing force, may be estimated as a first approximation by the major axis (125) and the minor axis (124) of the ellipse and by the distance (123) of the flattened area to the major axis of the ellipse perpendicular to the deposition surface.

Based on this geometry, it is possible to calculate the position of the nip line (130) relative to the axis of rotation (121) of the application roller, where the strip of pre-impregnated fibers (110) joins the deposition surface (101).

The selection of the hardness of the application roller and therefore its deflection under the effect of the pressing force depends on the nature of the material deposited and on the geometric complexity of the shape to be made. Thus, for the layup on a flat surface of fibers pre-impregnated with a thermosetting polymer having a significant tackiness before curing, the application conditions, hardness of the application roller and pressing force are such that the roller remains of a circular section with an almost linear contact with the deposition surface along the nip line.

On the other hand, for the layup of fibers pre-impregnated with a thermoplastic polymer, the application conditions are such that the roller is more strongly deflected so as to apply pressure for a longer time on the stack of plies at the moving speed (192) of the deposition head.

As an illustrative example and in order to establish the orders of magnitude, a roller with a nominal diameter of 70 mm having a shore hardness of 40, is deflected so that the distance (123) from the flattened area to the major axis of the ellipse is 30 mm under a pressing force of 1500 N.

The deflection amplitude of the application roller may be calculated empirically based on the application roller characteristics and the pressing force. Based on these magnitudes of deflection, the theoretical position of the nip line (130) with respect to the rotation axis of the application roller may be determined by geometrical relations.

More particularly for the layup of fibers pre-impregnated with a thermoplastic polymer, the pre-impregnated fibers (110) and the deposition surface (101) have to be heated to a temperature generally close to the melting temperature of the impregnating polymer at the time of the fiber layup.

This heating is for example carried out by a heating laser emitting a laser beam (150) directed substantially towards the nip line (130).

The distribution of the heated surface between the heated portion of the deposited strip (151) and the heated portion of the deposition surface (152) depends on the centering of the laser beam with respect to the nip line, which may be characterized by the parameters h_{b} and hₛ, the inclination a of the laser beam with respect to the deposition surface (101) and the working distance (155) of the laser.

The optimum heating profile depends heavily on the nature of the material that is implemented and on its microstructure. Research work shows the existence of correlations between the quality of the parts obtained using this method of pre-impregnated fibers layup: inter/intra-ply porosities, interlaminar resistance, crystallinity rate, thermal degradation and residual stresses; and the setup of the heating laser and more particularly the location of a target temperature at the nip line, but also with the layup speed.

As a non-limiting example, the layup of carbon fibers pre-impregnated with a polyetheretherketone (PEEK), with a layup speed of 30 m/min, a laser with a height (h_{b}+hₛ) of 28 mm and a target temperature of 350° C., an optimum setting is obtained with an angle α of 19° and an offset of the center of the laser beam of −14 mm, that is to say h_{b}=0 and hₛ=28 mm, with respect to nip line (130), i.e. heating is entirely applied to the deposition surface.

For the same material deposited at 24 m/min an optimum setting is obtained for an angle α of 20° and a distribution h_{b}=4.2 mm and hₛ=23.8 mm.

These optimal conditions are determined by trials and the results are transcribed into a database or charts, allowing those skilled in the art to make the appropriate adjustments according to the material and the intended layup conditions.

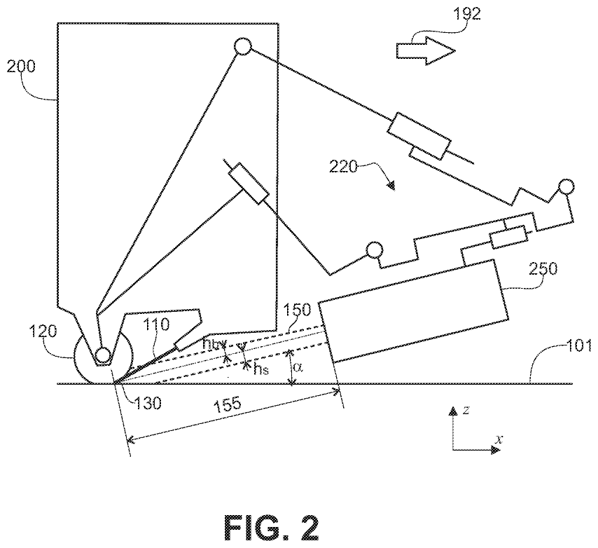

FIG. 2 schematically shows an exemplary embodiment of a deposition head (200) comprising a polyarticulated linkage device (220) for adjusting the position of an optical device (250) focusing the heating laser (150), relative to the rotational axis of the application roller (120), wherein a circle represents a pivot type connection and a rectangle α sliding type connection.

Thus, this polyarticulaed linkage device (220) makes it possible to adjust the angle α, the working distance (155) and the positioning h_{b}, hₛ of the heating laser (150) with respect to the nip line (130), in order to obtain optimum deposition parameters with regard to a given operation.

Other adjustment kinematics are possible for this polyarticulated linkage but are generally quite complex to ensure both the necessary freedom in the adjustments, and once said adjustments have been made, to ensure a stable position of the optical device after locking the connections.

Advantageously, the kinematics of the polyarticulated linkage is modeled, which makes it possible to determine the position of the links to obtain a position and an orientation of the optical device by an inverse kinematic analysis.

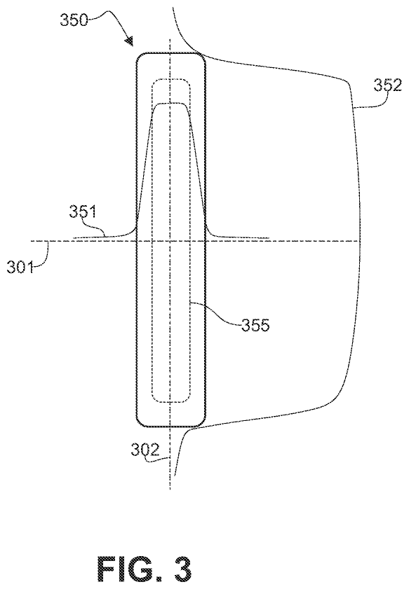

FIG. 3 the laser spot (350) projected by the optical device is substantially rectangular in shape with a power distribution (351, 352) along its central axes, transverse axis (31) and longitudinal axis (302), such that it comprises an area of substantially constant power (355) centered on the laser spot.

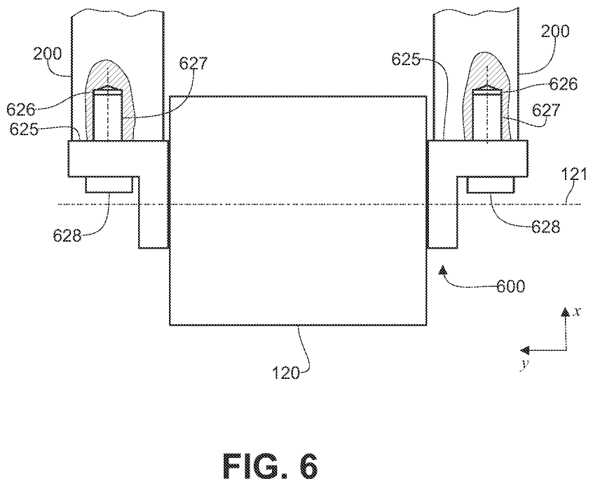

FIG. 6 the application roller (120) is pivotally mounted about its axis of rotation (121) on a support (600) allowing it to be placed and held in position on the deposition head (200), according to a specific interface, thus ensuring the possibility of using several types of application rollers, of different diameter or different hardnesses on the same deposition head.

According to an exemplary embodiment, the specific interface comprises reference surfaces comprising a planar abutment surface (625) and one or more centering bore holes (626).

The support (600) may include surfaces configured to bear on the planar abutment surface of the deposition head and one or more locating pins (626) adapted to cooperate with the centering bore holes of the deposition head.

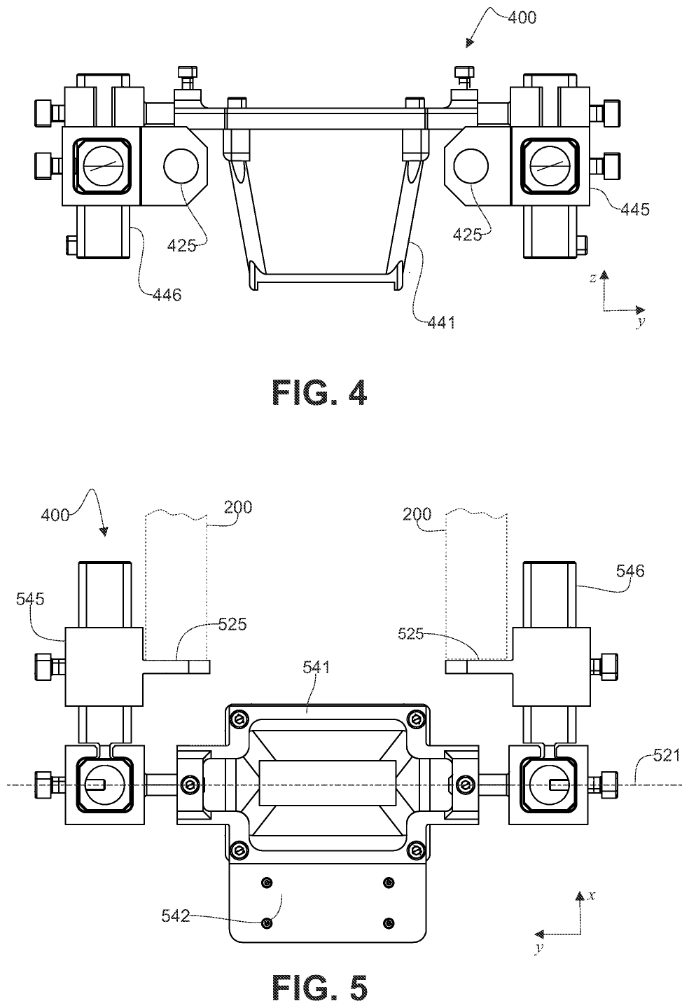

According to an exemplary embodiment, the locking of the support (600) to the deposition head may be achieved by radially expandable means (not shown) set up on said locating pins, associated with clamping means (628) making it possible, during their clamping, to achieve both the expansion of the radially expandable means in the centering bore holes (626) and pressing the support against the planar abutment surface (625).

[FIG. 4] and [FIG. 5] an adjustment device (400) is installed on the deposition head in place of the application roller.

To this end, according to this embodiment, the adjustment device comprises bearing surfaces (525) capable of abutting against the planar abutment of the deposition head (200), and bore holes (425) suitable for mounting the locating pins with radially expandable means for centering and fixing the adjustment device on the deposition head according to the same principle and the same reference surfaces than those used for the assembly of the application roller, i.e. the planar abutment surface and the centering bore holes of the deposition head.

The adjustment device (400) comprises a screen holder (541) capable of holding a translucent screen consisting of glass, paper or plastic, the screen not being shown in FIGS. 4 and 5.

The screen holder (541) is connected by a lockable pivot link, along a pivotal axis (521) with respect to the adjustment device.

The screen holder (541) includes a camera holder (441) for positioning a video camera perpendicular to the translucent screen and at an appropriate distance from a surface of the screen.

According to an exemplary embodiment, the screen holder may comprise a platform (542) configured to hold accessories, more particularly an inclinometer configured to be fixed on said platform, for measuring an orientation angle of the screen holder about the articulation axis (521) of the lockable pivot link.

According to an exemplary embodiment, the adjustment device (400) comprises adjustment sliders (545) in a lockable sliding connection on so-called horizontal guide profiles (546), for adjusting the position of the axis (521) of the pivotal connection in a direction perpendicular to the bearing surface (525), as well as adjustment sliders (445) in a lockable sliding connection on so-called vertical guide profiles (446), for adjusting the position of the axis (521) of this pivotal connection in a direction parallel to the bearing surface (525).

Thus, the position of the axis (521) of the pivotal connection is adjustable in order to be coincident, according to an exemplary embodiment, with the calculated theoretical position of the longitudinal axis of the laser spot, thus allowing the same adjustment device to be used for making adjustments corresponding to application rollers of different diameters.

According to such an embodiment, the positioning of the translucent screen includes the steps of:
determining the application roller adapted to the layup conditions: diameter, hardness of the material constituting said roller,
calculating the relative position of the nip line vis-à-vis the rotation axis of the application roller according to these conditions,
determining the theoretical relative position of the laser spot vis-à-vis the nip line (h_{b}, hₛ and angle α) for obtaining the desired spatial distribution of heating,
deducing the position of the translucent screen vis-à-vis the reference surfaces so that the axis of the lockable pivot link is confused with the longitudinal axis of the laser spot.

Since the theoretical position of the translucent screen is thus determined, this setting is applied precisely to the positioning of the translucent screen using the adjustment means (445, 545) and a measuring means such as a caliper for this purpose.

According to a more sophisticated embodiment, in order to make these adjustments easier, at least one of each pair of guide profiles (446, 546) may comprise an optical rule and the sliders associated with these guide profiles may comprise an adapted reader.

The person skilled in the art understands that another initial positioning of the translucent screen is possible without substantially modifying the adjustment method. For example, according to another embodiment, the position of the axis of the lockable pivot link is set so as to be coincident with the rotation axis of the selected application roller.

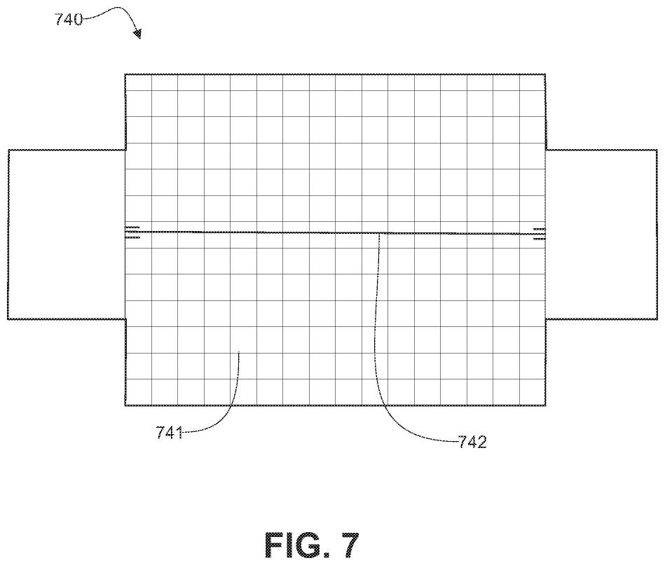

FIG. 7 a translucent screen (740) is set on the screen holder of the adjustment device. This translucent screen is, according to exemplary embodiments, made of glass, paper or frosted plastic, and advantageously comprises a grid (741) engraved on one of its faces.

Advantageously, the grid comprises a line (742) materializing the position of the axis of the pivot link of the adjustment device.

The deposition head comprises a pilot laser of reduced power, being conveyed by the optical device, so as to produce a laser spot similar in shape and power distribution to the one produced by the heating laser. When the pilot laser is directed, by means of the optical device, to the translucent screen (740), the laser spot is projected and becomes visible on the translucent screen.

The heating laser is in the infrared spectrum, usually around 1000 nm wavelength and is therefore not visible, the pilot laser is in the visible spectrum, around 650 nm wavelength.

Returning to FIG. 4, the camera support (441) makes it possible to install a video camera, configured to observing the face of the translucent screen opposite the face on which the laser spot is projected by the pilot laser.

By way of non-limiting example, the video camera is of the 1080p Full HD type with an acquisition frequency of 30 frames per second. This type of camera is commonly available commercially, for example under the Logitech® C920 HD Pro reference.

According to an exemplary embodiment, the targeted layup conditions, in particular the hardness of the application roller and the pressing force, the distribution of the heating between the deposition surface and the deposited fibers, are known.

The shape of the laser spot and the power distribution in this laser spot are also known from the characteristics of the optical device.

This known information makes it possible by geometric relations, on the one hand, to theoretically calculate the relative position of the nip line with respect to the axis of rotation of the roller, and on the other hand to determine the angle of orientation a of the heating laser as well as its relative position (h_{b}, hₛ, working distance) with respect to the nip line to obtain a desired result.

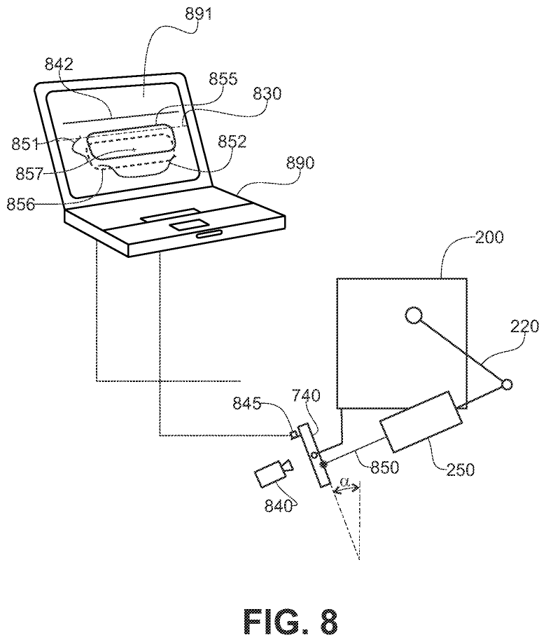

FIG. 8 the system of the invention makes it possible to make the adjustments of the optical system (250) by means of the polyarticulated linkage (220) connecting said optical device to the deposition head (200) to obtain the desired result.

To this end, with the application roller disassembled and the adjustment device installed in its place, the translucent screen (740) of the adjustment device, after its pivot connection axis has been correctly positioned with respect to the deposition head (200) so as to be coincident with the theoretical position of the longitudinal axis of the laser spot in relation to the targeted deposition operation, is oriented by the targeted angle α with respect to a theoretical normal to the deposition surface.

The systems and the described operations do not require the deposition head (200) to be positioned with respect to a deposition surface that obstructs access and visibility. The adjustment device being placed in position relative to the reference surfaces of the deposition head, the orientation in space of the translucent screen relative to the deposition head is deduced from the intended orientation of the deposition head with respect to the deposition surface in the corresponding fiber layup program.

An inclinometer (845), installed on the accessory platform of the adjustment device, allows this adjustment to be made. Said inclinometer is advantageously connected to computer means (890), here a laptop, which allows to display clearly the value of the angle α regardless of the orientation of the deposition head during the adjustment.

A first coarse adjustment of the position of the optical device (250) by means of the polyarticulated linkage (220) may be carried out so as to project, with the pilot laser (850), a laser spot on the translucent screen (740).

The video camera (840) makes it possible to acquire an image of this laser spot and, the camera being connected to the computer means (890), an image of the laser spot (855) is displayed on the video screen of the computer means, which is used as a control monitor (891).

Advantageously, said video screen also displays the line (842) representing the position of the axis of rotation of the translucent screen, as engraved on the frost of said screen, and which corresponds, according to an exemplary embodiment, to the theoretical position of the longitudinal axis of the laser spot.

A processing of the image acquired by the camera (840) allows the display of the laser spot on the control monitor (891) in false colors depending on the distribution of the light intensity. Additionally, the light power distribution profiles (851, 852) in the laser spot may also be displayed.

Advantageously, the theoretical position (830) of the nip line may also be displayed on the control monitor (891).

The grid of the translucent screen makes it possible to calculate the scale factor of the display on the control monitor and thus to measure the distances and angles between the different elements displayed, by conventional image analysis means or even with a ruler.

The display is in real time at the camera acquisition frequency. According to an embodiment, the computer means (890) displays on the control monitor (891) the theoretical position (856) of the laser spot as it has been calculated according to the desired result.

According to a simplified embodiment, only the theoretical position of the center (857) of the laser spot is displayed on the control monitor.

According to a first embodiment of this system, in order to adjust the position and the orientation of the optical device (250), the technician sees, from the display on the control monitor, a qualitative information of the deviation between the orientation of the optical device with respect to its intended theoretical position. That is, he knows, at least approximately, from the display and his experience, in which direction to act on the polyarticulated linkage (220) to approach the desired result.

Thus, the technician acts directly on the polyarticulated linkage (220) to gradually bring the optical device adjustment closer to the target setting by observing the real-time display on the control monitor, for example, by matching the displayed laser spot (855) with its theoretical target position (856) and by ensuring that the displayed light power distribution (851, 852) is in an acceptable configuration, i.e. relatively uniform on the surface of the laser spot.

Throughout this adjustment, the translucent screen (740) and the camera (840) are fixed with respect to the reference surfaces of the deposition head (200) and this adjustment allows the orientation in space of the optical device by successive approximations while remaining quick in implementation.

According to another and more automated embodiment, the computer means (890) comprises a kinematic model of the polyarticulated linkage (220) and also comprises an image analysis computer program.

According to this embodiment, the computer means also comprises in a memory the characteristics of the optical device, in particular the focal length and the working distance as well as parameters describing the characteristics of the projected laser spot in particular:
the position of the power peak along the main axes of the laser spot,
the width and length of the laser spot at 50% of the peak intensity,
the shape of the power distribution in the laser spot, without this list being exhaustive.

These data are usually available as manufacturer data, alternatively they may be determined by trials.

The screen having been positioned opposite the reference surfaces of the deposition head (200) and inclined by the targeted angle α, the optical device is roughly oriented towards the screen and the image of the laser spot produced by the pilot laser (850) is acquired by the camera (840).

The computer means carry out an analysis of the image acquired by the camera and the distribution of the light power, the image analysis computer program calculates in particular:
the position of the centroid of the laser spot,
the dimensions of the laser spot and compares them with the manufacturer parameters,
the statistical moments of order 2 of the power distribution with respect to the barycenter which makes it possible to refine the analysis of the orientation in space of the optical device with respect to the translucent screen.

From this data a computer program assesses the relative position of the optical device with respect to the translucent screen and, using an inverse kinematic model of the polyarticulated linkage, indicates, on the control monitor (891) the correction to be made to the various settings of this polyarticulated linkage in order to obtain the expected theoretical result.

Thus, the invention also pertains to a method for adjusting the heating laser of a deposition head using the adjustment system described above.

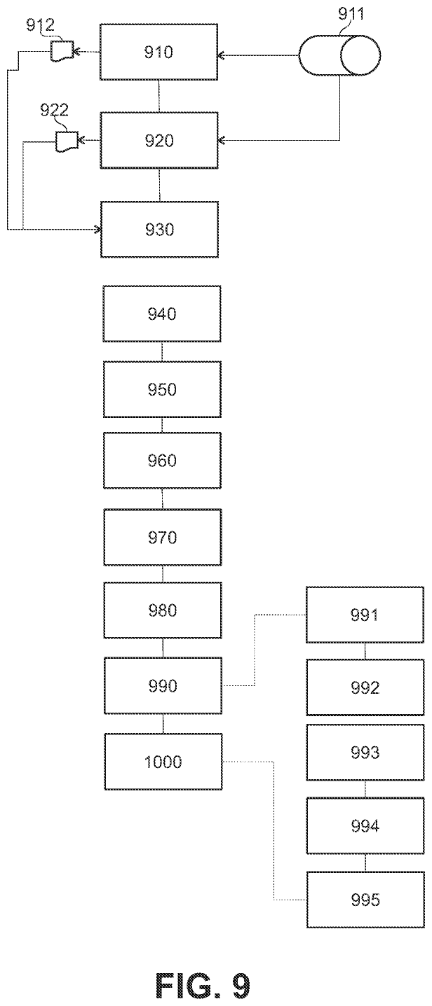

FIG. 9 according to a first preparation step, depending on the intended layup conditions, speed, material, type of application roller, inclination of the deposition head, pressing force, this first step consists in calculating (910) the position of a nip line relative to the reference surfaces of the deposition head. The input data for this step is for example obtained from a database (911).

A second preparation step is to obtain (920) the heating conditions for the fiber layup. These conditions are obtained, for example from the database (911).

From the results (912, 922) of the previous steps, a third preparation step consists in determining (930) the laser heating conditions, in particular the position of the laser spot with respect to the nip line (h_{b}, hₛ) and the a orientation of the heating laser.

These first three steps of preparation require only computer means or even tables or charts, and do not require the adjustment device at hand. They can be carried out in advance to cover several deposition schemes and their results summarized in the form of practical sheets that can be used by a technician responsible for adjusting or checking the optical device.

To perform the adjustment itself, an initial step is to install (940) the adjustment device at the location intended to receive the application roller on the deposition head. This installation includes adjusting the position of the axis of the pivot link of the screen holder so that this axis is coincident with the theoretical position of the longitudinal axis of the laser spot targeted for the fiber layup operation as determined during the first three steps.

The next step is to orient (950) the translucent screen by the angle α determined during the third preparation step.

The next step is to project (960) the laser spot obtained by the pilot laser conveyed by the optical device onto the translucent screen. As indicated above, this projection is carried out by orienting and positioning the optical device roughly by means of the polyarticulated linkage.

Once the laser spot is projected onto the translucent screen, the next steps are to acquire (970) the image of the laser spot by the video camera and to display it on the control monitor.

At least the center of the laser spot as it should be located relative to the axis of the pivot connection of the translucent screen, for example coincident with it, taking into account the calculations made during the third preparation step is displayed (990) on the control monitor. Alternatively or in a complementary manner, this display comprises an image of the contours of the laser spot such that it should be positioned in the case of a perfect adjustment.

The last step is for the technician to act (1000) on the polyarticulated linkage so as to make the display of the theoretical position of the laser spot coincide with the spot projected on the translucent screen and displayed on the control monitor.

As indicated above, depending on the embodiment, several levels of assistance can be provided to the technician via dedicated computer programs.

Especially when the computer means include a kinematic model of the polyarticulated linkage, according to optional steps of calculating (992) an initial configuration of the polyarticulated linkage according to an image analysis step (991) of the light distribution in the laser spot, comparing (993) this light distribution with a targeted configuration and deducing (994) deviations from it and either displaying these deviations to assist the technician, either determining (995) a target configuration of the polyarticulated linkage minimizing the deviations by a inverse kinematic model, in order to assist the technician during his action on the polyarticulated linkage.

The best adjustment techniques of the prior art using an adjustment template, make it possible to achieve a repeatability of positioning of the optical device and the laser spot of the order of +/−2 mm and do not make it possible to analyze the power distribution in the laser spot therefore do not allow a rigorous adjustment of the working distance, nor of the effective orientation of the laser.

By implementing the adjustment system described above a positioning repeatability of +/−0.5 mm, an accuracy of the orientation of the heating laser of 0.1°, and an adjustment accuracy of the working distance of +/−1 mm are achieved.

Thus, this system is not only useful for the adjustment of the heating device of . . . a deposition head but also for its cyclical inspection.

1-8. (canceled)

9. A deposition head for automated fiber layup of pre-impregnated fibers on a deposition surface comprising:
an application roller rotating around a rotation axis carried by the deposition head, the application roller being removable and positioned relative to the deposition head by reference surfaces;
pressure means configured to applying an application pressure of the application roller to the deposition surface;
a heating laser for heating the pre-impregnated fibers and the deposition surface during automated layup;
an optical device configured for focusing a laser beam and to project a laser spot with a power distribution at a working distance, the optical device being connected to the deposition head by an adjustable polyarticulated linkage, configured to adjust a relative position of the optical device with respect to the deposition head;
a pilot laser of reduced power as compared with the heating laser, configured to be conveyed by the optical device;
the deposition head further comprising:
an adjustment device configured to be installed on the deposition head in place of the application roller and positioned in relation to the deposition head by the reference surfaces;
a translucent screen connected to the adjustment device by a lockable pivot link around a pivot axis and configured to receive the laser of the pilot laser projected by the optical device on a face exposed to the optical device;
a camera oriented towards a face opposite the exposed face of the translucent screen and configured to acquire an image of the translucent screen; and
a control monitor configured for displaying the image acquired by the camera.

10. The deposition head of claim 9, comprising adjustment means for adjusting a position of the lockable pivot link relative to the reference surfaces.

11. The deposition head of claim 9, comprising an inclinometer for adjusting an orientation of the translucent screen about the pivot axis.

12. The deposition head of claim 9, wherein the translucent screen comprises a grid on the exposed face.

13. A system comprising the deposition head of claim, and computer means (890) comprising calculation means configured to analyze the image acquired by the camera.

14. A method for adjusting a deposition head for automated fiber layup of pre-impregnated fibers on a deposition surface with an adjustment system comprising computer means comprising calculation means configured to analyze the image acquired by a camera, the deposition head comprising:
an application roller rotating around a rotation axis carried by the deposition head, the application roller being removable and positioned relative to the deposition head by reference surfaces;
pressure means configured to applying an application pressure of the application roller to the deposition surface;
a heating laser for heating the pre-impregnated fibers and the deposition surface during automated layup;
an optical device configured for focusing a laser beam and to project a laser spot with a power distribution at a working distance, the optical device being connected to the deposition head by an adjustable polyarticulated linkage, configured to adjust a relative position of the optical device with respect to the deposition head;
a pilot laser of reduced power as compared with the heating laser, configured to be conveyed by the optical device;
an adjustment device configured to be installed on the deposition head in place of the application roller and positioned in relation to the deposition head by the reference surfaces;
a translucent screen connected to the adjustment device by a lockable pivot link around a pivot axis and configured to receive the laser of the pilot laser projected by the optical device on a face exposed to the optical device;
a camera oriented towards a face opposite the exposed face of the translucent screen and configured to acquire an image of the translucent screen and to transmit the image to the computer means;
a control monitor configured for displaying the image acquired by the camera;
the method comprising the steps of:
I) calculating a position relative to the reference surfaces of a nip line of the application roller on the deposition surface when the application roller is applied to the deposition surface with the application pressure;
II) obtaining target conditions for heating, by the heating laser, the deposition surface and the pre-impregnated fibers during the layup operation;
III) determining from a result of step II) an orientation angle α of the heating laser and a theoretical relative position of a center of the laser spot with respect to the nip line at the working distance;
IV) installing the adjustment device in place of the application roller and positioning the translucent screen relative to the reference surfaces according to a result of steps I) to III), V) orienting the translucent screen by its lockable pivot link according to the orientation angle α determined in step III;
V) projecting the laser spot onto the translucent screen with the pilot laser;
VI) acquiring the image of the laser spot with the camera and displaying it on the control monitor,
VII) displaying on the control monitor the theoretical position of the center of the laser spot obtained in step III; and
VIII) acting on the adjustable polyarticulated linkage to make the center of the image of the laser spot coincide with the theoretical position of the center of the laser spot displayed on the control monitor.

15. The method of claim 14, further comprising the steps of:
analyzing with the computer means a distribution of the light intensity of the laser spot acquired in step VII,
comparing the light distribution of the laser spot acquired in step VII with the power distribution of the laser spot projectable by the optical device;
deducing deviations from the comparison and displaying the deviations;
acting on the adjustable polyarticulated link to minimize the deviations.

16. The method of claim 15, wherein the computer means comprise a kinematic model of the adjustable polyarticulated linkage, the method comprising steps of:
calculating an initial configuration of the adjustable polyarticulated linkage based on the position of the image acquired in step VII and the kinematic model of the adjustable polyarticulated linkage,
determining a target configuration of the adjustable polyarticulatd linkage to make the center of the laser spot image coincide with the theoretical position of the center of the laser spot displayed on the control monitor according to the kinematic model of the adjustable polyarticulated linkage;
displaying the target configuration on the control monitor; and
during step IX acting on the adjustable polyarticulated linkage to reproduce the target configuration.
